(19) United States
(12) Patent Application Publication
(10) Pub. No.: US 2010/0008638 A1
(43) Pub. Date: Jan. 14, 2010

(54) INDEPENDENT PARALLEL IMAGE PROCESSING WITHOUT OVERHEAD

(76) Inventor: Auke Sjoerd Vanderschaar, Los Angeles, CA (US)

Correspondence Address: Robert D. Shedd, Patent Operations;THOMSON Licensing LLC, P.O. Box 5312, Princeton, NJ, 08543-5312, US

(21) Appl. No.: 12/449,232

(22) PCT Filed: Feb. 2, 2007
(86) PCT No.: PCT/US07/02949

§ 371 Date: Jul. 29, 2009

(51) Int. Cl. H04N 5/91

(52) U.S. Cl. 386/52; 386/E05.003

(57) ABSTRACT

An image processing system comprises an image processing manager, a plurality of processors for processing an input sequence of images (e.g., movie), and a distributed file system for creating and storing an output file representing a sequence of processed images. The image processing manager allocates an image subregion of the sequence of images to each one of the plurality of processors for processing. Each one of the plurality of processors processes the assigned image subregion and provides a corresponding processed image subregion to the distributed file system. The distributed file system writes the processed image subregions from each of the plurality of processing units to a corresponding portion of the output file.

### BACKGROUND OF THE INVENTION

The present invention generally relates to image processing systems and, more particularly, to image processing systems that process a large amount of images such as found in a movie.

Typical image processing operations are format conversions, resizing and scene change detection. In order for an image processing system to process a large amount of images (e.g., a movie) in a reasonable amount of time, the image processing system comprises many processing units, where each processing unit performs a particular task. One example of such an image processing arrangement is a pipeline processing architecture, where the results (data) from one processing unit is fed to the next processing unit. Another example of an image processing arrangement is a parallel-type architecture, where each processing unit processes a part of the image. In this case, the results from each of the processing units are then combined by another processor to create the resulting output image. U.S. Patent Application Publication No. 2004/0239996 is an example of such a system.

However, either of the above-described approaches to an image processing system requires synchronization between the processing units and transfer of data and message exchange. Unfortunately, these tasks can introduce a substantial overhead, complicate the design and do not scale well if more and more processing units must be added to the system.

SUMMARY OF THE INVENTION

As noted above, any image processing system that uses any serial, or sequential, image processing results in not only having potential system inefficiencies such as processing bottlenecks but also results in systems that are non-scaleable. Therefore, and in accordance with the principles of the invention, an apparatus for processing a sequence of images to provide a sequence of processed images comprises a plurality of processing units, each processing unit processing a respective image subregion of the sequence of images to provide a corresponding processed image subregion; and data storage for storing each corresponding processed image subregion in a corresponding portion of an output file representing the sequence of processed images.

In an illustrative embodiment of the invention, an image processing system comprises an image processing manager, a plurality of processors for processing a sequence of images (e.g., movie), and data storage for storing (a) an input file (or stream) representing a sequence of images (e.g., a movie) and (b) an output file (or stream) representing a sequence of processed images (e.g., an encoded (MPEG2, H.264) file). The image processing manager allocates an image subregion of the stored sequence of images to each one of the plurality of processors for processing. Each one of the plurality of processors processes the assigned image subregion and provides a corresponding processed image subregion to a portion of the output file.

In another illustrative embodiment of the invention, an image processing system comprises an image processing manager, a plurality of processors for processing an input sequence of images (e.g., movie), and a distributed file system for storing an output file representing a sequence of processed images. The image processing manager allocates an image subregion of the input sequence of images to each one of the plurality of processors for processing. Each one of the plurality of processors processes the assigned image subregion and provides a corresponding processed image subregion to the distributed file system. The distributed file system writes the processed image subregions from each of the plurality of processing units to a corresponding portion of the output file.

### BRIEF DESCRIPTION OF THE DRAWINGS

FIG. 1 shows an illustrative image processing system in accordance with the principles of the invention;

FIG. 2 shows an illustrative embodiment of an image processing system in accordance with the principles of the invention;

FIGS. 3 and 4 show illustrative flow charts for use in an apparatus in accordance with the principles of the invention;

FIG. 5 shows another illustrative embodiment of an image processing system in accordance with the principles of the invention;

FIG. 6 shows another illustrative embodiment of an image processing system in accordance with the principles of the invention; and

FIG. 7 shows another illustrative embodiment of an image processing system in accordance with the principles of the invention.

### DETAILED DESCRIPTION

Other than the inventive concept, the elements shown in the figures are well known and will not be described in detail. Also, familiarity with image processing systems is assumed and not described herein. For example, other than the inventive concept, familiarity with image processing operations such as format conversions, resizing and scene change detection is assumed and not described herein-in. Likewise, familiarity with video formats such as such (but not limited to) MPEG-1, MPEG-2, MPEG-4, Motion JPEG (avi), 3GP (video phone format) and audio formats MP3 and WMA is also assumed and not described herein. In addition, other than the inventive concept, distributed file system operation is well-known and not described herein. It should also be noted that the inventive concept may be implemented using conventional programming techniques, which, as such, will also not be described herein. Finally, like-numbers on the figures represent similar elements.

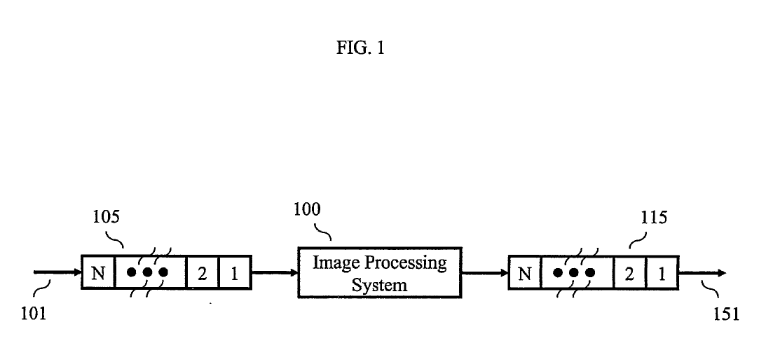

An illustrative image processing system 100 in accordance with the principles of the invention is shown in FIG. 1. Before describing different illustrative embodiments of image processing system 100, a brief overview of system operation is provided. Image processing system 100 receives an input video signal 101, which is represented by a file (or stream) 105 representing a sequence of images (e.g., a movie) and provides an output file (or stream) 115, representing a sequence of processed images (e.g., a movie), which is representative of an output video signal 151. As noted above, the particular type of image processing operation performed by image processing system 100, e.g., format conversions, resizing and scene change detection, is not important to the inventive concept and, as such, is not described herein. However, what is important is “how” image processing system 100 processes the sequence of images. In particular, and in accordance with the principles of the invention, the input file is divided into a number of image subregions (1 through N) each of which is processed by a corresponding processing unit (not shown in FIG. 1) of image processing system 100 to provide a respective processed image subregion (1 through N) of the output file 115. In other words, portions of the output file (or stream) are automatically provided by each corresponding processing unit. As a result, the multi-processing arrangement represented by image processing system 100 provides a simple and scalable distributed processing scheme that works both for temporal and spatial image processing algorithms. Illustratively, each image subregion comprises one, or more, image frames in, e.g., an MPEG-2 format.

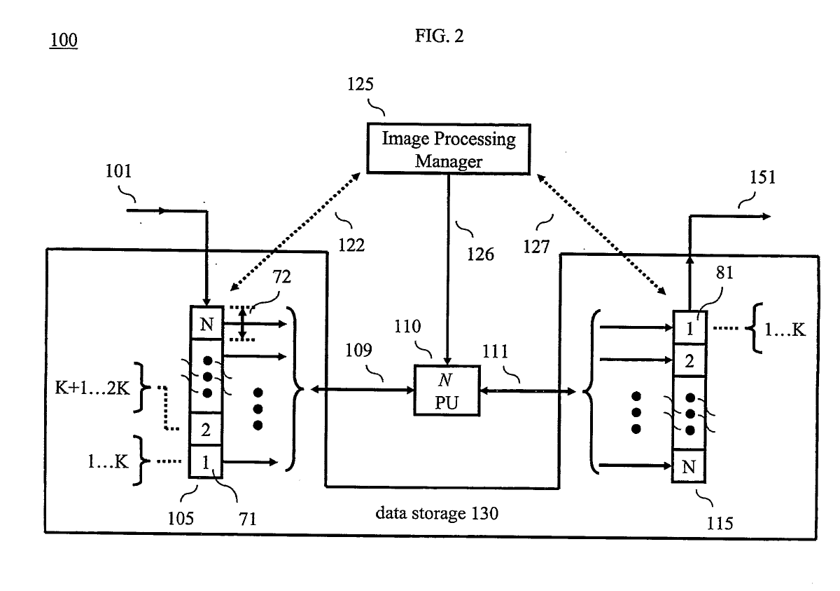

Turning now to FIG. 2, an illustrative embodiment of ah image processing system in accordance with the principles of the invention is shown. Image processing system 100 comprises N processing units (PU) 110 (where N>1), data storage 130 and an image processing manager 125. Data storage 130 provides access to an input file, or stream, 105, and an output file, or stream, 115. Input file 105 is representative of a video signal 101 comprising an input sequence of images; and output file 115 is representative of an output video signal 151 comprising an output sequence of processed images. Data storage 130 is representative of, e.g., a hard-disk drive(s), magnetic tape, memory etc. It should be noted that data storage 130 may provide for more than one type, or form, of data storage. Each of the N processing units (PU) 110 and image processing manager 125 is representative of one, or more, stored-program control processors and may, or may not, include memory. It should be noted that image processing manager 125 may control other functions of image processing system 100 that are not described herein. In this regard, only those parts of image processing system 100 relevant to the inventive concept are shown in FIG. 2. For example, memory for storing computer programs, or software, executed by each of the N processing units 110 is not shown in FIG. 2. Further, specific bus connections with regard to address, data and control for interconnecting the various components of image processing system 100 are not shown for simplicity. It should also be noted that the term “memory” as used herein is representative of data storage, e.g., random-access memory (RAM), read-only memory (ROM), a hard-disk, tape, etc.; and may be internal and/or external to image processing system 100 and is volatile and/or non-volatile as necessary. It should also be noted that input file 105 is a simplification of a file input/output (I/O) process for the purposes of explaining the invention. Other than the inventive concept, file I/O processes such as reading, processing and writing streams of information, e.g., a video stream, is known in the art and not described herein.

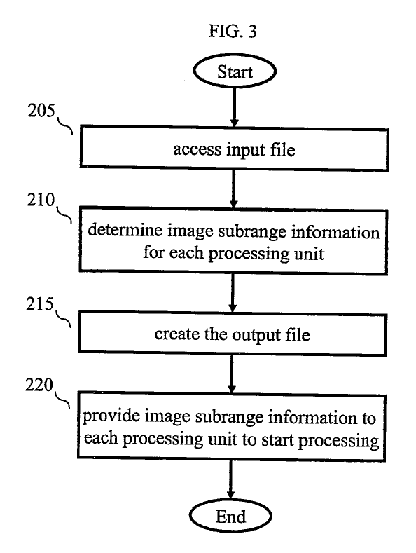

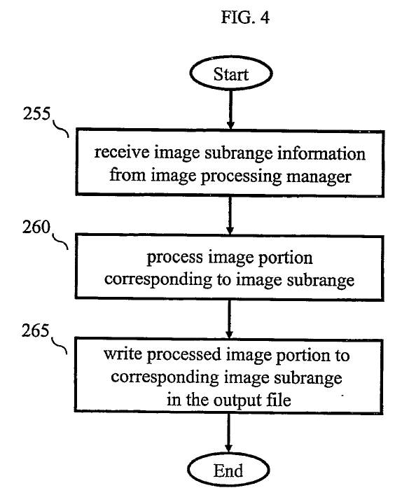

In further describing the illustrative embodiment shown in FIG. 2, reference will also be made to FIGS. 3 and 4, which show illustrative flow charts for use in image processing system 100 in accordance with the principles of the invention. In step 205 of FIG. 3, image processing system 100 accesses input file 105 via control path 122. (Again, this is a simplification and represents, e.g., requesting information from data storage 130 to, e.g., get the size of a file, etc.) In step 210, image processing manager 125 determines (via control path 122) the size of input file 105 in image frames and divides input file 105 into N image subregions, where each image subregion comprises K image frames, where K>0. This is illustrated in FIG. 2 for image subregion 1 (also indicated by reference numeral 71), where image subregion 1 comprises image frames 1 through K. Similarly, image subregion 2 comprises image frames K+1 through 2K+1, etc., continuing down through image subregion N. In this example, it is assumed that all N processing units process input file 105, therefore, the value for K is easily determined by image processing manager 125 by simply dividing the size of input file 105 in image frames by the value of N, i.e., the number of processing units. As a result, in step 210 image processing manager 125 also determines the address ranges for each image subregion in input file 105 as illustrated by address range 72 of FIG. 2. In the context of this description, an address range corresponds to a range of image frame numbers for that image subregion (which could also be further mapped to actual physical or virtual addresses of memory). For example, the address range for image subregion 1 is image frames 1 to K; while the address range for image subregion 2 is images frames K+1 to 2K. In step 215, image processing manager 125 creates an output file 115 of the same size as the input file as determined in step 210, via control path 127. Finally, in step 220, image processing manager 125 assigns respective image subrange information to each of the N processing units 110, via control path 126, such that each of the N processing units 110 start to process a different portion of input file 105 (as described below with respect to FIG. 4). For example, each of the N processing units requests, via path 109, that data storage 130 provide the respective assigned image subrange from input file 105.

Turning now to FIG. 4, in step 255 each of the N processing units 110 receive there assigned image subrange information from image processing manager 125, via control path 126. In step 260, each of the N processing units 110 independently processes their respective image subregion (provided via path 109) in accordance with one, or more, image processing operations such as, but not limited to, format conversions, resizing and scene change detection, etc., to provide a processed image subregion. In step 265, each of the N processing units 110 writes their processed image subregion to output file 115 using the same allocated address range. For example, if one of the N processing units 110 was assigned to process an image subregion corresponding to image frames 1 to 100, then that processing unit would write its processed image subregion to that portion of output file 115 corresponding to image frames 1 to 100 (also represented in FIG. 1 by reference numeral 81). In other words, each of the N processing units 110 writes into a separate part of output file 115.

Thus, and in accordance with the inventive concept, the above-described parallelization method for image processing assigns to each processing unit a part of an image sequence. Each processing unit processes this part independently and writes out the results directly in its own range of the output file. Consequently, other than the initial allocation of image subregion information by image processing manager 125, the processing units do not require any communication such as message passing or synchronization between the processing units and the processed image subregions do not require subsequent combination by a separate processor to create the output file. This results in a very simple and very scalable distributed processing scheme and works both for temporal and spatial image processing algorithms.

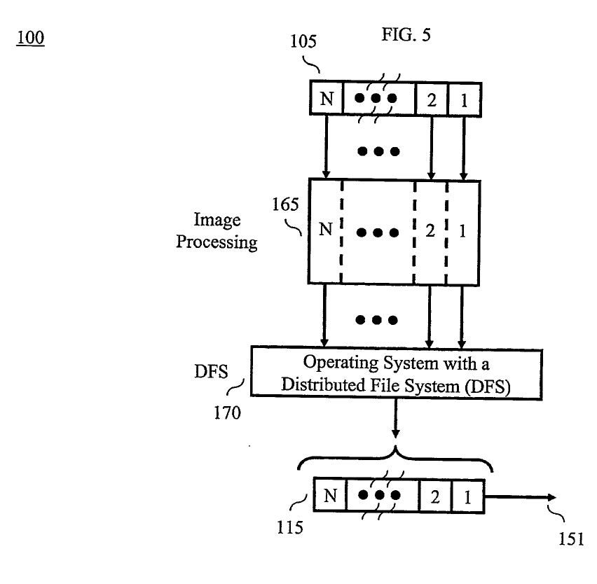

Referring now to FIG. 5, another illustrative embodiment in accordance with the principles of the invention is shown. The diagram of FIG. 5 illustrates the inventive concept in the context of a high-level software architecture. In particular, an image processing system 100 comprises at least two layers of software. Parallel image processing software layer 165 comprises N image processes, each of which independently performs one, or more, processing operations on a corresponding one of the image subregions of input file (or stream) 105 to provide a corresponding processed image subregion. As described above, the image processing operations are illustrated by, but not limited to, format conversions, resizing and scene change detection, etc. Each of the N image processes writes its processed image subregion to a corresponding part of output file 115 via DFS layer 170, which is an operating system with a distributed file system (DFS). One example of DFS layer 170 is the “lustre” file system provided by Cluster File Systems, Inc. A DFS is by its nature parallel and does not really combine the various processed image subregions. DFS layer 170 ensures that the various processed image subregions are written at the correct location within output file 115 (based on the image subregion information provided by each of the N image processes) so that the sequence of processed images in output file 115 will be read out in the correct order at a later time as represented by output video signal 151. In other words, the inventive concept takes advantage of the capability of modern operating systems where seeking to a particular position in a file does not result in actually creating and writing prior to the position in that file. Thus, each of the N image processes writes to the same output file 115 but at different sections, or positions, in the output file. It should be noted that in actuality DFS layer 170 may also manage access to input file 115. However, this was simplified in FIG. 5 for the purposes of explaining the inventive concept.

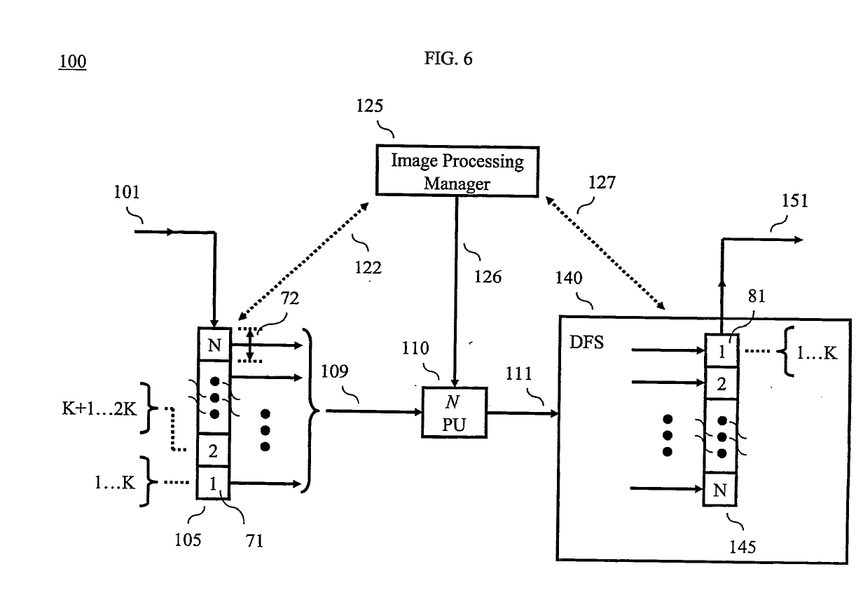

In view of the software architecture illustrated in FIG. 5, an illustrative image processing system implementing this software architecture is shown in FIG. 6. The embodiment of FIG. 6 is similar to the embodiment of FIG. 2 except that each one of the N processing units 110 now writes if processed image subregion to a particular portion of output file 145 via DFS 140. It should also be noted that data storage 130 (to which DFS 140 writes and reads data) is not explicitly shown in FIG. 6 in order to reduce clutter and is represented by input file 105 and output file 145. Also, it again should be noted that in actuality DFS 140 may also manage access to input file 115. However, this was simplified in FIG. 6 for the purposes of explaining the inventive concept. Finally, like the embodiment of FIG. 2, the flow charts of FIGS. 3 and 4 are also applicable to the embodiment shown in FIG. 6.

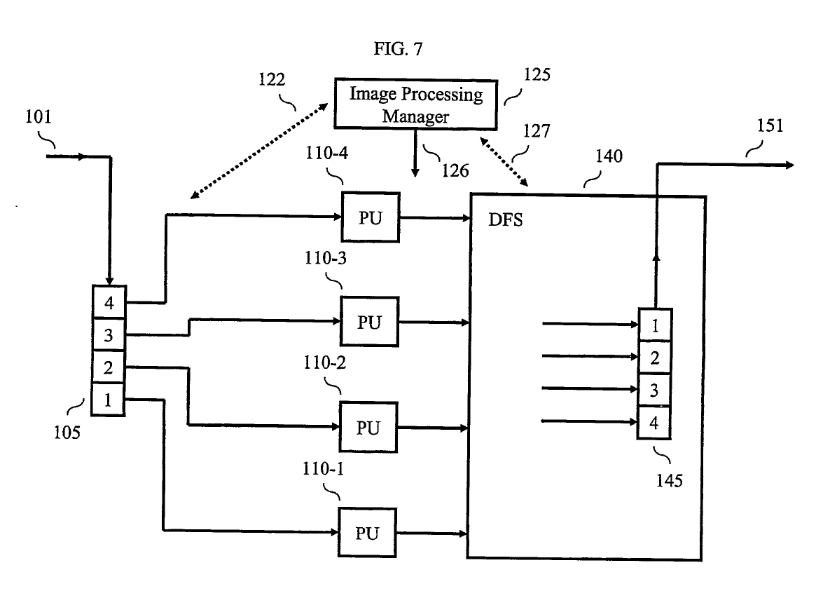

Another illustrative embodiment of the inventive concept is shown in FIG. 7 for N=4. As such, this particular embodiment is similar to the embodiment of FIG. 6. Image processing system 100 comprises four processing units (PU) 110-1, 110-2, 110-3 and 110-4, DFS 140 and an image processing manager 125. As described above, PU 110-1, PU 110-2, PU 110-3, PU 110-4 and image processing manager 125 are representative of one, or more, stored-program control processors and may, or may not, include memory. Again, data storage 130 is not explicitly shown to reduce clutter and is represented by input file 105 and output file 145. It should be noted that image processing manager 125 may control other functions of image processing system 100 that are not described herein. In this regard, only those parts of image processing system 100 relevant to the inventive concept are shown in FIG. 7. For example, memory for storing computer programs, or software, executed by each of the processing units PU 110-1, PU 110-2, PU 110-3 and PU 110-4, is not shown in FIG. 7. Further, specific bus connections with regard to address, data and control for interconnecting the various components of image processing system 100 are not shown for simplicity.

In further describing the illustrative embodiment shown in FIG. 7, reference will again be made to FIGS. 3 and 4, which show illustrative flow charts for use in image processing system 100 in accordance with the principles of the invention. In step 205 of FIG. 3, image processing system 100 accesses input file 105 via control path 122. (Again, this is a simplification and represents, e.g., requesting information from data storage 130 to, e.g., get the size of a file, etc.) In step 210, image processing manager 125 determines (via control path 122) the size of input file 105 and divides input file 105 into four image subregions. Illustratively, it is assumed that the total number of image frames in input file 105 is 400 and, therefore, K=100, i.e., each image subregion comprises 100 image frames. Thus, image subregion 1 corresponds to image frames 1 to 100 of input file 105; image subregion 2 corresponds to image frames 101 to 200 of input file 105; image subregion 3 corresponds to image frames 201 to 300 of input file 105; and image subregion 4 corresponds to image frames 301 to 400 of input file 105. As a result, in step 210 image processing manager 125 also determines the address ranges for each image subregion in input file 105. In step 215, image processing manager 125 creates an output file 145 of the same size as input file 105 as determined in step 210, via control path 127. Finally, in step 220, image processing manager 125 assigns respective image subrange information to each of the four processing units PU 110-1, PU 110-2, PU 110-3, PU 110-4. In particular, image processing manager 125 assigns, via control path 126, image frames 1 to 100 of input file 105 to PU 110-1; image frames 101 to 200 of input file 104 to PU 110-2; image frames 201 to 300 of input file 104 to PU 110-3; and image frames 301 to 400 of input file 104 to PU 110-4. As such, each of the four PUs, 110-1, 110-2, 110-3 and 110-4, start to process a different portion of input file 105.

Turning now to FIG. 4, in step 255 each of the four PUs, 110-1, 110-2, 110-3 and 110-4, receive there assigned image subrange information from image processing manager 125, via control path 126. In step 260, each of the four PUs, 110-1, 110-2, 110-3 and 110-4, independently processes their respective image subregion in accordance with one, or more, image processing operations such as, but not limited to, format conversions, resizing and scene change detection, etc., to provide a corresponding processed image subregion. In step 265, each of the four PUs, 110-1, 110-2, 110-3 and 110-4, writes their processed image subregion to output file 145 via DFS 140 using the same allocated address range. For example, since PU 110-1 was assigned to process an image subregion corresponding to image frames 1 to 100, then PU 110-1 writes its processed image subregion to that portion of output file 145 corresponding to image frames 1 to 100 via DFS 140. In other words, each of the four PUs, 110-1, 110-2, 110-3 and 110-4, writes into a separate part of output file 145.

As described above, an image processing system in accordance with the inventive concept eliminates communication overhead between processors since all of the required information (i.e., the image subregion information) is provided upfront. In addition, there is no additional requirement that the various processed image components be serially combined. As such, an image processing system in accordance with the principles of the invention is extremely scalable to, theoretically, an unlimited number of processors. Further, the inventive concept works both for non-temporal (spatial filtering and format conversions) and temporal type of algorithms (scene change detection, temporal filtering). For example take scene change detection for a processing unit in the context of the example shown in FIG. 7 (e.g., PU 110-3). In order to determine whether the first image frame in the range for which PU 110-3 is responsible (illustratively, this is image frame 201) is the start of a new scene, PU 110-3 can start analyzing a few frames earlier (i.e., frames from the previous image subregion of input file 105, e.g., image frames 199 and 200) in order for PU 110-3 to determine whether image frame 201 is the start of a new scene. However, PU 110-3 does not need any input, or information, from another processing unit such as PU 110-2, i.e., PU 110-3 needs no communication from PU 110-2 and does not have to wait for PU 110-2.

It should be noted that although the inventive concept was illustrated in the context of all N processing units processing an input file, the inventive concept is not so limited. For example, image processing manager 125 may allocate a portion of the N processing units to process the input file if, e.g., the input file was less than a particular size, one of the N processing units reported a fault, etc. Further, as noted above, each of the N processing units are not limited to processing image frames only from their image subregion. As noted above, a processing unit can process image frames from another subregion in order to, e.g., determine if the first frame of an assigned image subregion is the start of a new scene.

In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied in one or more integrated circuits (ICs). Similarly, although shown as separate elements, any or all of the elements may be implemented in a stored-program-controlled processor, e.g., a digital signal processor, which executes associated software, e.g., corresponding to one or more of the steps shown in, e.g., FIGS. 3-4, etc. It is therefore to be understood that numerous modifications may be made to the illustrative embodiments and that other arrangements may be devised without departing from the spirit and scope of the present invention as defined by the appended claims.

1. An apparatus for processing a sequence of images to provide a sequence of processed images, the apparatus comprising:
a plurality of processing units, each processing unit processing a respective image subregion of the sequence of images to provide a corresponding processed image subregion; and
data storage for storing each corresponding processed image subregion in a corresponding portion of an output file representing the sequence of processed images.

2. The apparatus of claim 1, wherein each image subregion comprises at least one image frame.

3. The apparatus of claim 1, further comprising:
a distributed file system for writing the processed image subregions from each of the plurality of processing units to the corresponding portions of the output file.

4. The apparatus of claim 1, wherein the data storage comprises a memory.

5. The apparatus of claim 1, wherein the output file is representative of a movie.

6. The apparatus of claim 1, further comprising:
a processor for allocating to each of the plurality of processing units which image subregion to process.

7. A method for use in processing a sequence of images to create a processed sequence of images, the method comprising:
partitioning the sequence of images into image subregions, each image subregion having a least one image frame;
processing each of the image subregions in parallel to provide processed image subregions; and
writing each processed image subregion to a preassigned portion of an output file;
wherein the output file represents the processed sequence of images.

8. The method of claim 7, further comprising the step of:
creating the output file with a distributed file system.

9. The method of claim 7, wherein the sequence of images and the processed sequence of images represents a movie.

10. The method of claim 7, wherein the partitioning step includes the step of:
allocating to each one of a plurality of processing units a particular one of the image subregions.

11. The method of claim 10, wherein the processing step includes the step of:
each one of the plurality of processing units writing its processed image subregion to its preassigned portion of the output file.

12. The method of claim 7, wherein the writing step includes the step of:
storing the output file in a memory.
